(19) United States
(12) Patent Application Publication
(10) Pub. No.: US 2010/0027781 A1
(43) Pub. Date: Feb. 4, 2010

(54) METHOD AND APPARATUS FOR ENHANCING PERFORMANCE OF DATA ENCRYPTION STANDARD (DES) ENCRYPTION/DECRYPTION

(76) Inventors: Duane E. Galbi, Cambridge, MA (US); David G. Lewis, Framingham, MA (US); Kirk S. Yap, Framingham, MA (US)

Correspondence Address: INTEL CORPORATION;c/o CPA Global, P.O. BOX 52050, MINNEAPOLIS, MN, 55402, US

(21) Appl. No.: 11/961,845

(22) Filed: Dec. 20, 2007

(51) Int. Cl. H04L 9/28

(52) U.S. Cl. 380/29; 380/28

(57) ABSTRACT

A method and apparatus for increasing performance of Data Encryption Standard (DES) and Triple DES (3DES) cipher operation is provided. A critical path through a plurality of rounds in a multi-round cycle to perform a cipher operation is reduced by reducing the number of exclusive OR (XOR) operations in the critical path. An R state element is expanded to 48-bits and each round stage uses the 48-bit expanded R state element which results in a reduction of the number of XOR operations to one per round in the cipher operation plus one additional XOR operation per cipher operation. In addition logic organization is symmetric which further increases the overall performance of DES and 3DES.

### FIELD

This disclosure relates encryption/decryption to and in particular to Data Encryption Standard (DES).

### BACKGROUND

The Data Encryption Standard (DES) is described in Federal Information Processing Standards (FIPS) Publication (Pub) 46-3. DES Encryption is performed by performing 16 table lookups and associated data swaps to encode a 64-bit data block. A table lookup and the associated data swaps may be referred to as a “round”. Hence, DES processes the 64-bit data block in 16 rounds. The 3-Data Encryption Standard (3-DES) performs three times the number of rounds performed by DES.

There are two key metrics for evaluation performance of DES. One metric is the maximum speed at which a data block can be encrypted and the other metric is the total aggregate bandwidth which can be encrypted, for example, the encryption of a 10 Mega bits per second (Mbs) data stream. A system may include multiple DES encryption units that operate in parallel in order to achieve the aggregate bandwidth.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a system 100 that includes an embodiment of a crypto unit that performs Data Encryption Standard (DES) encryption/decryption according to the principles of the present invention;

FIG. 2 is a block diagram of an embodiment of the crypto unit shown in FIG. 1 for performing DES or 3DES encryption/decryption;

FIG. 3 is a block diagram illustrating one round of the complex key-dependent computation for DES or 3DES;

FIG. 4 is a block diagram illustrating operations performed by the composition function “f” shown in FIG. 3;

FIG. 5 is a block diagram of an embodiment of a cycle that performs a plurality of rounds of DES or 3DES;

FIGS. 6A-6C illustrate transformations performed on a portion of the composition function shown in FIG. 5;

FIG. 7 illustrates an embodiment of an initial stage in a multi-stage (round) cycle for the critical R-path that reduces the number of XOR operations per cycle;

FIG. 8 is a block diagram of an embodiment of a cycle that performs a plurality of rounds of DES or 3DES according to the principles of the present invention;

FIG. 9 is a block diagram of an embodiment of a cycle that performs four rounds of DES or 3DES and inter-cycle logic; and

FIG. 10 is a flowgraph that illustrates an embodiment of a method for performing a plurality of rounds of DES according to the principles of the present invention.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

The performance of DES encryption/decryption may be 10 Mega bits per second (Mbs), 100 Mbs, 1 Giga bits per second (Gbs), or 10 Gbs for a unidirectional bit stream. If encrypting/decryption a full-duplex stream, the bit rate is doubled.

For example, in order to achieve 1 Giga bits per second (Gbs) full-duplex 3-DES operation in a system having a clock frequency of 533 Megahertz (Mhz), twelve cycles are allocated per 64-bits to encode/decode. The forty-eight (16*3) rounds required per 64-bits for 3DES, requires four rounds to be performed per cycle.

Increasing throughput of an encryption unit has the dual benefit of decreasing the number of encryption units and increasing the maximum throughput of a single encryption/decryption stream.

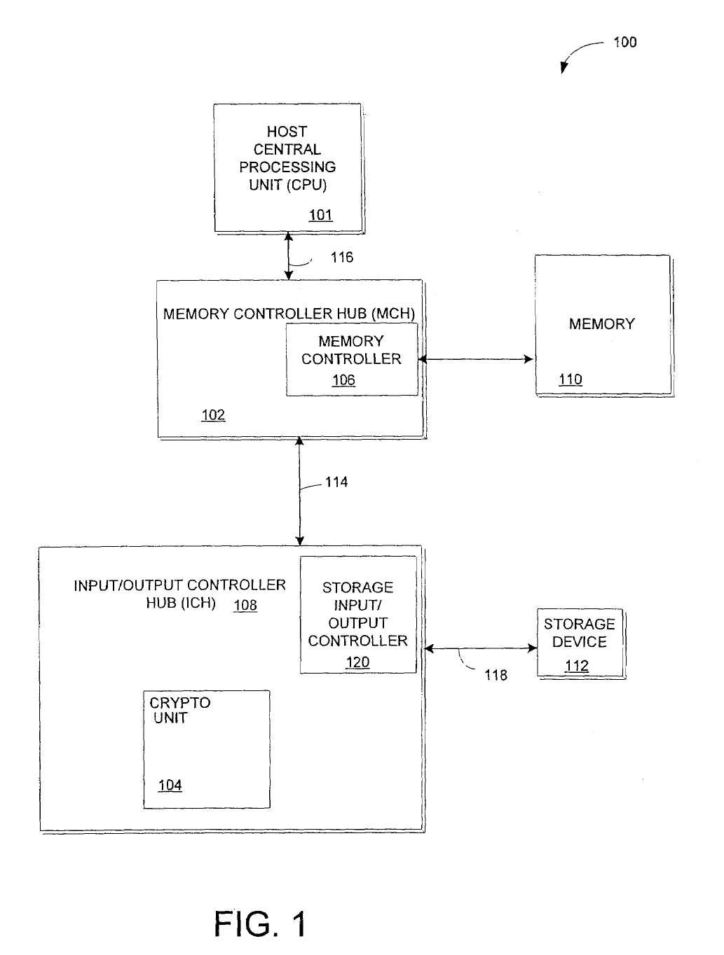

FIG. 1 is a block diagram of a system 100 that includes an embodiment of a crypto unit 104 that performs Data Encryption Standard (DES) encryption/decryption according to the principles of the present invention.

The system 100 includes a processor 101, a Memory Controller Hub (MCH) 102 and an Input/Output (I/O) Controller Hub (ICH) 104. The MCH 102 includes a memory controller 106 that controls communication between the processor 101 and memory 110. The processor 101 and MCH 102 communicate over a system bus 116.

The processor 101 may be any one of a plurality of processors such as a single core Intel® Pentium IV® processor, a single core Intel Celeron processor, an Intel® XScale processor or a multi-core processor such as Intel® Pentium D, Intel® Xeon®processor, or Intel® Core® Duo processor or any other type of processor.

The memory 110 may be Dynamic Random Access Memory (DRAM), Static Random Access Memory (SRAM), Synchronized Dynamic Random Access Memory (SDRAM), Double Data Rate 2 (DDR2) RAM or Rambus Dynamic Random Access Memory (RDRAM) or any other type of memory.

The ICH 104 may be coupled to the MCH 102 using a high speed chip-to-chip interconnect 114 such as Direct Media Interface (DMI). DMI supports 2 Gigabit/second concurrent transfer rates via two unidirectional lanes. The ICH 104 includes a crypto unit 104 which includes functions to perform DES and 3DES symmetric-key ciphers for bulk encryption and decryption. Symmetric ciphers may be used for ensuring privacy of network packets in Virtual Private Network (VPN) gateways and in Transport Layer Security (TLS). The crypto unit may also include functionality for Advanced Encryption Standard (AES), Secure Hash Algorithm (SHA-1) or Hashed Message Authentication Code (HMAC).

The ICH 104 may also include a storage I/O controller 120 for controlling communication with at least one storage device 112 coupled to the ICH 104. The storage device 112 may be, for example, a disk drive, Digital Video Disk (DVD) drive, Compact Disk (CD) drive, Redundant Array of Independent Disks (RAID), tape drive or other storage device. The ICH 104 may communicate with the storage device 112 over a storage protocol interconnect 118 using a serial storage protocol such as, Serial Attached Small Computer System Interface (SAS) or Serial Advanced Technology Attachment (SATA).

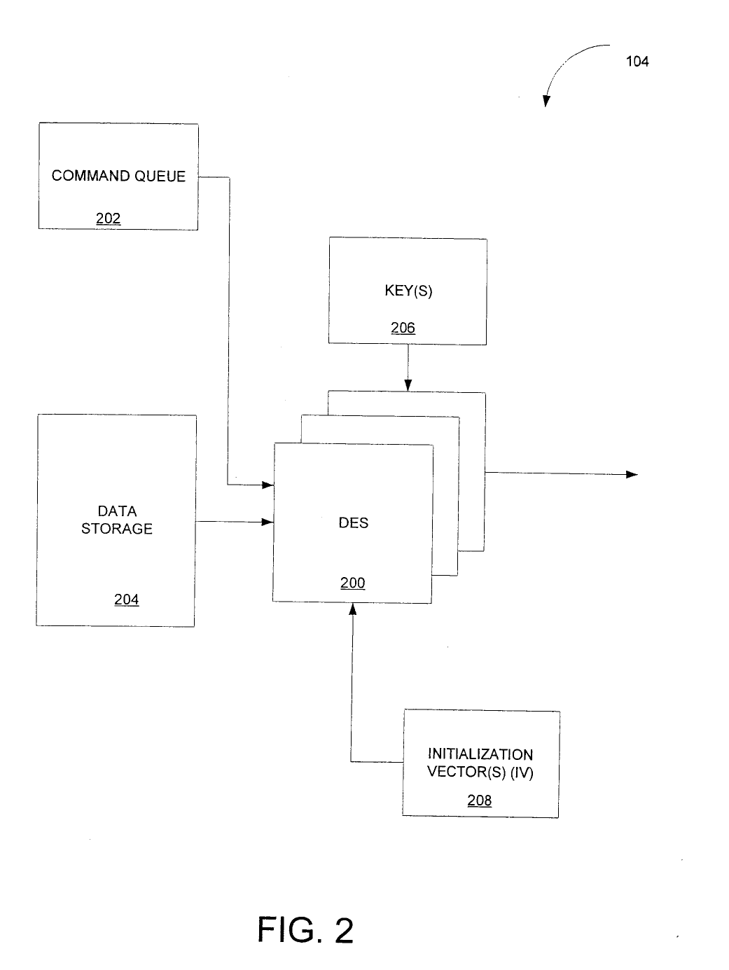

FIG. 2 is a block diagram of an embodiment of the crypto unit 104 shown in FIG. 1 for performing DES or 3DES encryption/decryption. The crypto unit 104 includes a plurality of DES blocks 200 used for DES or 3DES ciphers. Each DES block 200 has access to initialization vectors 208 and keys 206. Command requests, for example, to encrypt or decrypt data enter the crypto unit 104 through the command queue 202. The commands are removed from the command queue 202 and processed by one of the DES units 200. The data to be encrypted/decrypted is stored in data storage 204 which may be a Random Access Memory (RAM).

The DES algorithm as described in Federal Information Processing Standards (FIPS) Publication 46-3 enciphers and deciphers blocks of data consisting of 64 bits under control of a 64 bit key. A 64-bit block to be enciphered is subjected to an initial permutation, then to a complex key-dependent computation using a key schedule generated from the key and finally to a permutation which is the inverse of the initial permutation. The initial permutation rearranges the bits of the 64-bit block as defined in FIPS Publication 46-3 to produce a permuted input, for example, bit 58 of the 64-bit block is the Most Significant Bit (MSB) of the permuted input, bit 50 of the 64-bit block is the MSB-1 bit and bit 7 of the 64-bit input block is the Least Significant Bit (LSB) of the permutted input. The permuted input is input to the complex key-dependent computation which produces a pre-output block.

The complex key-dependent computation for DES includes sixteen iterations (rounds) of a cipher function that operates on a 32-bit block and a 48-bit block to produce a 32-bit block. The complex key-dependent computation for 3DES includes 48 rounds. Each iteration may also be referred to as a round.

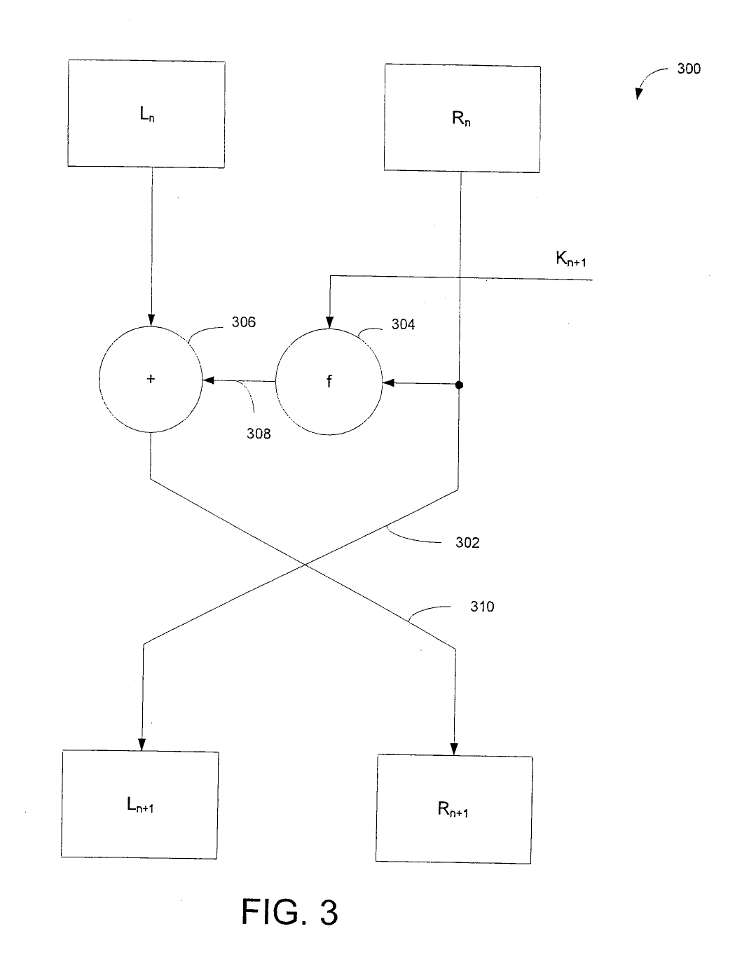

FIG. 3 is a block diagram illustrating one round (iteration) of the complex key-dependent computation. In the first round (n=0) the 64-bit permuted input variable is split into two 32-bit blocks labeled L and R. Each round uses 48-bits of the 64-bit key which is labeled K.

The inputs to the round are the 64 permutted input block split into a 32-bit Lₙ block and a 32-bit block Rₙ and a 48-bit Key Kₙ₊₁. The outputs are a 32-bit Lₙ₊₁ block and a 32-bit Rₙ₊₁ block.

The output block Lₙ₊₁ is computed as follows:

Lₙ₊₁=Rₙ

As shown in FIG. 3, input block Rₙ is directed on path 300 to output block Lₙ₊₁.

The output block Rₙ₊₁ is computed as follows:

Rₙ₊₁=Lₙ̂f(Rₙ and Kₙ₊₁)

A composite function “f” 304 is performed on the 32-bit input block Rₙ and the 48-bit key Kₙ₊₁. An Exclusive OR function is performed on the result of the composite function 308 and the 32-bit input block Lₙ The output of the Exclusive OR operation 310 is directed on path 310 to 32-bit output block Rₙ₊₁.

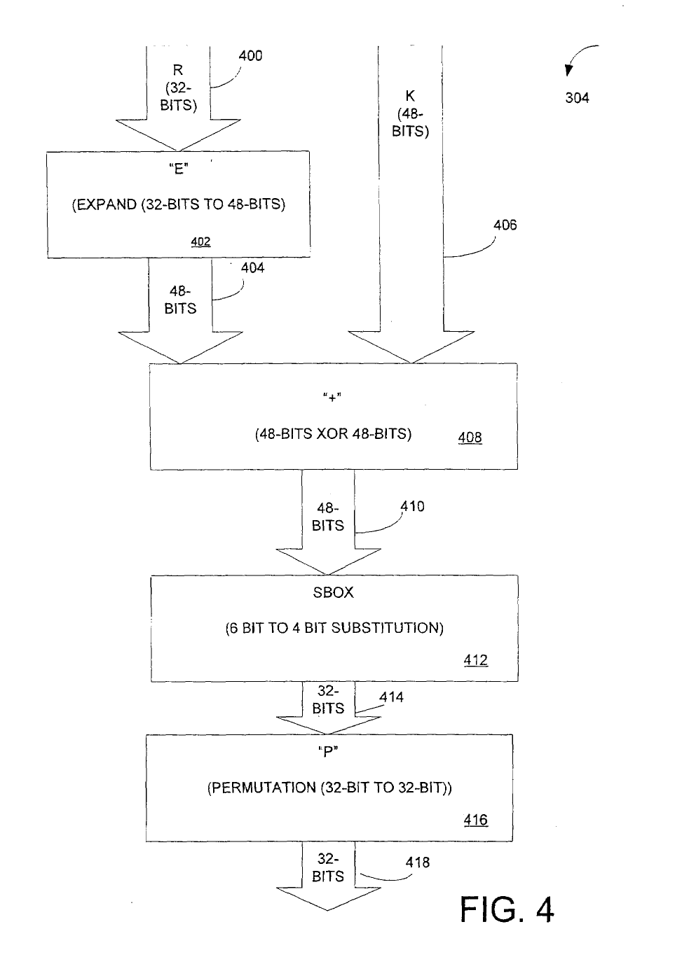

FIG. 4 is a block diagram illustrating operations performed by the composition function “f” 304 shown in FIG. 3. Referring to FIG. 4, first an expansion operation (E) 402 is performed on a 32 bit input R block 400 to create a 48 bit expanded output block 404. The expansion operation 402 performs a fixed mapping between the 32 bit input block 400 and the 48 bit expanded output block 404, that is, this is zero time remapping. Next, an exclusive OR (XOR) operation (̂) 408 is performed using the 48-bit expanded output block 404 from the expansion operation 42 and a 48-bit key 406 to produce a 48-bit lookup table index 410. Then a substitution operation (SBOX) 412 is performed by performing a lookup into a table with the 48-bit lookup table index 410. The 48-bit lookup table index 410 has 8 groups of 6-bit indexes. Each of the 6-bit indexes into the 48-bit lookup table index returns a respective 4-bit value stored in the lookup table to provide a 32-bit (8*4) output block 414. Finally, the permutation operation (P) 416 swaps bits in the 32-bit output block 414 received from SBOX 412 to provide a 32-bit result block 418 of the composition function. In order to generate the 32-bit result block 418, bits in the 32-bit output block 414 are swapped by the P operation 416 in the order specified in FIPS-PUB 46-3 such that no bits are repeated.

Thus, the composition function “f” 340 shown in FIG. 4 may be represented as:

f=P(sbox(E(R)̂K))

In order to reduce the amount of logic required to implement the DES algorithm described in FIPS-PUB 46.3, the logic required to implement the composition function “f” may be reused multiple times by adding addition state elements and circulating data through the same logic for a plurality of cycles. This requires the addition of a state machine to schedule the key that is used by each cycle and to control the circulation of the data through the associated data-path. In an embodiment, four rounds 314 (FIG. 3) are performed per cycle, with 4 cycles required to perform the 16 round DES and 12 cycles required to perform the 48 round 3DES.

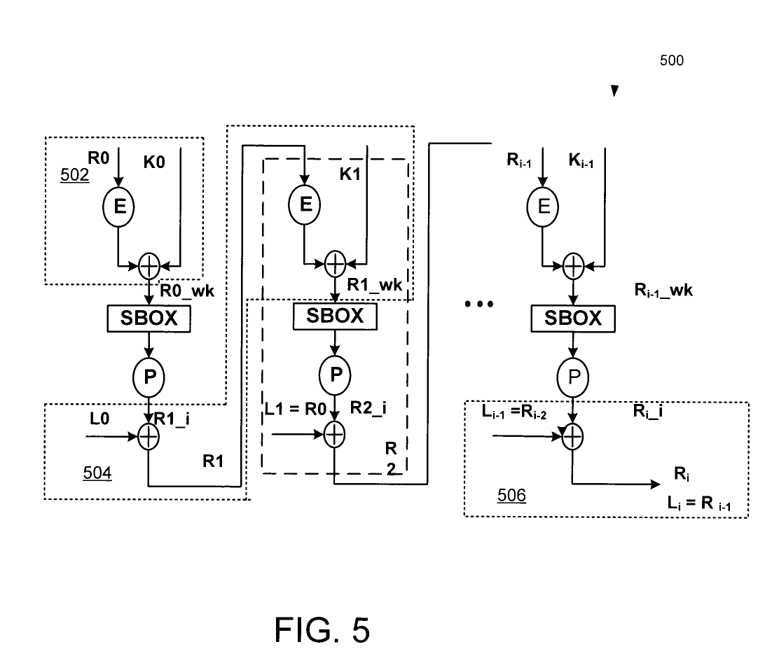

FIG. 5 is a block diagram of an embodiment of a cycle that performs a plurality of rounds of DES or 3DES. Psuedo code for the data path logic for four rounds, with four 32 bit input blocks R0-R3, L0-L3 and four 48-bit key schedules (K0-K3) to generate four 32-bit output blocks R1-R4 and L1-L4 is shown below in Table 1.

TABLE 1

Round 1:

| | |
|---|---|
| Critical R-path: | R1 = L0 \hat{ } P(sbox(E(R0) \hat{ } K0[47:0])); |
| Non-Critial L-path: | L1=R0; |

Round 2:

| | |
|---|---|
| Critical R-path | R2 = L1 \hat{ } P(sbox(E(R1) \hat{ } K1[47:0])); |
| Non-Critial L-path: | L2=R1; |

Round 3:

| | |
|---|---|
| Critical R-path | R3 = L2 \hat{ } P(sbox(E(R2) \hat{ } K2[47:0])); |
| Non-Critial L-path: | L3=R2; |

Round 4:

| | |
|---|---|
| Critical R-path: | R4 = L3 \hat{ } P(sbox(E(R3) \hat{ } K3[47:0])); |
| Non-Critial L-path: | L4=R3; |

Referring to Table 1, the inputs to Round 1 are 32-bit block L0, 32-bit block R0 and 48-bit key schedule K0. The outputs from Round 1 are 32-bit block R1 and 32-bit block L0 that are computed as discussed earlier in conjunction with FIGS. 3 and 4. The computation of 32-bit blocks R1-R4 takes longer than the computation of 32-bit blocks L1-L4. Thus, the computation of 32-bit blocks R1-R4 is the critical path that determines the time to compute one round of DES or 3DES.

As shown in Table 1, the critical path includes a plurality of Exclusive OR (XOR operations with two XOR operations (denoted by the symbol “̂”) per round. There is one XOR operation performed by the f function “P(sbox(E(R)̂K[47:0])” and another XOR operation is performed on the result of the f function and the L data. Thus, the critical path for a cycle in which four rounds are performed includes eight XOR (̂) operations, with two XOR operations used to compute each of the four data blocks R1-R4, one per round in the four-round cycle. The path that provides the key schedule (K0-K3) is not critical because the key schedule (K0-K3) for the four rounds in the cycle is a fixed value that is stored in memory with 48-bits of the key schedule used per round.

The cycle for computing a plurality of rounds 500 includes an initial stage 502, a function stage 504 and a final stage 506. The initial stage 502 performs an expansion function E on the 32-bit R input and performs an XOR operation on the 48-bit expanded R input and the 48-bit key schedule. The final stage 506 performs an XOR operation on the result of the L path and the result of the R path to provide a 32-bit R output which is input to the next cycle.

Both the expansion operation (E) and the exclusive OR operation (XOR) are linear functions. A linear function has a distributivity property, that is, E(ÂB)=E(A)̂E(B) and an associativity property, that is, (âb)̂c=â(b̂c). These properties may be used to decrease the number of XOR operations in the critical path.

These properties are used to perform transformations on a portion of the f function processed by the function stage 500 shown in FIG. 5.

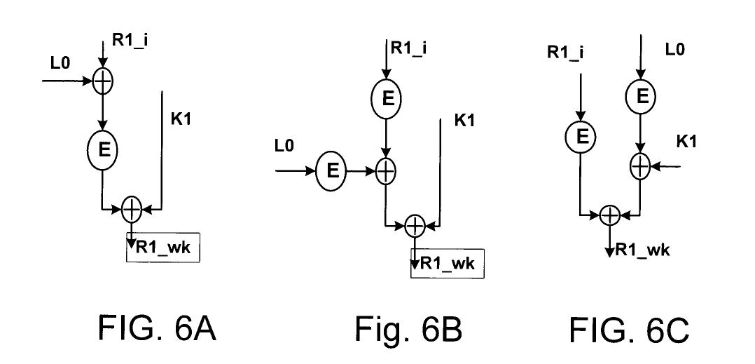

FIGS. 6A-6C illustrate transformations performed on a portion of the composition function shown in FIG. 5. Referring to FIG. 6A which illustrates the portion of the f function 500 shown in FIG. 5 to be transformed, the portion of the f function 500 includes two XOR operations and performs the following function:

Ri_{—}wk=(E(Lᵢ₋₁̂Ri_{—}i)̂Ki)
where:
   Ri_wk is the Expanded Ri (48-bit) xored with key (48-bit)
   Ri_i is the Intermediate Ri (32-bit) (prior to the XOR with Lᵢ₋₁).

FIG. 6B is the result of the transformation using the distributivity property of the operations shown in FIG. 6A. The result may be written as follows:

Ri_{—}wk=(E(Lᵢ₋₁)̂E(Ri_{—}i))̂Ki)

Instead of expanding the result of the XOR operation on the 32-bit L data block and 32-bit R data block, the expansion is performed separately on each of the data blocks. The XOR operation is then performed on the expanded data blocks (L and R).

FIG. 6C is the result of the transformation using the associativity property of the operations shown in FIG. 6B. The fact that “L” values are calculated before “R” values is taken into account in order to perform the transformation. The result may be written as follows:

Ri_{—}wk=(E(Lᵢ₋₁)̂Ki)̂E(Ri_{—}i))

An expansion operation to expand the L data block to 48-bits is performed in the non-critical L path. Next, an XOR operation is performed on the expanded L block and the key schedule K in the non-critical L path. The result of the XOR operation is used to perform an XOR operation on the expanded R data block. This results in a reduction of an XOR stage through the critical R path.

The resulting operations for a 4-round implementation of the DES function that make use of the transformations are shown below in Table 2. As shown, the number of XORs in the critical timing path from “R” to “R4” is reduced from eight to five, that is, there is one XOR per round in the R critical path in each of the four rounds per cycle and one additional XOR per cycle to obtain R4 from R4_i.

TABLE 2

Round 1:

Critical R-path:

R1_i = P(sbox(E(R) \hat{ } K0[47:0]));
R1_wk = (E(L) \hat{ } K1) \hat{ } E(R1_i);

Non-Critial L-path:

L1=R;

Round 2:

Critical R-path:

R2_i = P(sbox(R1_wk));
R2_wk = (E(L1) \hat{ } K2) \hat{ } E(R2_i);

Non-Critial L-path:

L2= L \hat{ } R1_i

Round 3:

Critical R-path:

R3_i = P(sbox(R2_wk));
R3_wk = (E(L2) \hat{ } K3) \hat{ } E(R3_i);

Non-Critial L-path:

L3= L1 \hat{ } R2_i;

Round 4:

Critical R-path:

R4_i = P(sbox(R3_wk));
R4 = L3 \hat{ } R4_i;

Non-Critial L-path:

L4 = L2 \hat{ } R3_i;

The transformations described in conjunction with FIGS. 6A-6C and Table 1 based on the distributivity and associativity properties of a linear function allows optimization of the critical path through a round function. The number of XOR stages in the critical R-path is reduced from two to one by moving one of the XOR stages to the non-critical L-path. However, in addition to one XOR stage per round in the critical R-path, in a multi-round cycle, there is an overhead of one additional XOR to calculate the final R value for the multi-round cycle (R4=L3 ̂ R4_i). That is, one additional XOR stage is used per cycle to transform the 48-bit R output of the cycle to a 32-bit R output. Thus, in a four round cycle, there is overhead of one additional XOR for every four rounds. The overhead of one additional XOR per cycle may be reduced by increasing the number of rounds per cycle. However, this would result in an increase in the cycle time which would result in a corresponding decrease in throughput.

An embodiment of the present invention further decreases the number of XOR stages in the critical R-path. In an embodiment, in a four round cycle, the number of XOR stages in the critical path is reduced to four per cycle. In addition, logic organization is symmetric which further increases the overall performance of DES and 3DES.

An embodiment of the present invention for a four round cycle removes the overhead of the additional XOR operation per cycle in the final stage 504 shown in FIG. 5. Instead of one additional XOR operation (XOR stage) per cycle, there is only one additional XOR stage for a 16-round (4 cycles) DES or 48-round (12 cycles) 3DES calculation. Thus, the total number of XOR stages in the critical path to perform a 16-round DES calculation is 4 per cycle (for each of the four cycles) plus one additional XOR, that is, a total of 17 XOR stages.

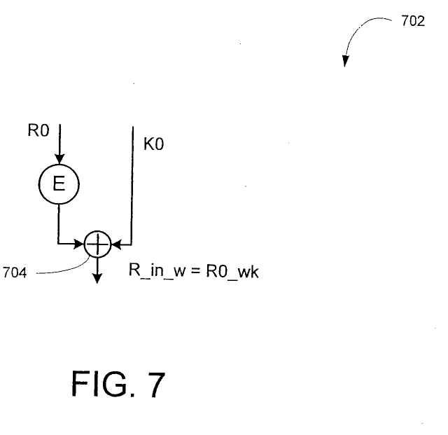

FIG. 7 illustrates an embodiment of an initial stage 702 in a multi-stage (round) cycle for the critical R-path that reduces the number of XOR operations per cycle. In the initial stage 702 shown, the 32-bit R0 input to the cycle is expanded to a 48-bit R input and the 48-bit R input is input to an XOR stage 704 where an XOR operation is performed on the 48-bit R input and the key schedule to produce a 48-bit R_in_w input.

The logic in the initial stage 702 shown in FIG. 7 may be represented by the following pseudo code:

R_{—}in_{—}w=E(R_{—}in)̂K0[47:0];

Thus, the input “R” state register (R0_wk) in the initial stage 702 is expanded to 48 bits wide instead of a 32-bit wide state register. Instead of initializing the “R” state register with the R input bits, these bits are expanded to 48-bits and XORed with the initial key (K0) value. As the data loops through the “R” state element (Ri_wk), the “R” state element always contains a pre-computed XOR with the next compression key that will be used. Thus, the “R” state domain (Ri_wk) remains expanded to 48-bits and does not transform back to 32-bits after every 4 rounds. The “R” input to each round cycle other than the initial cycle is L3̂R4_i.

In an initial stage in a multi-stage (round) cycle for the non-critical L-path, the 32-bit L0 input to the cycle is expanded to a 48-bit L input and the 48-bit L input is input to an XOR stage where an XOR operation is performed on the 48-bit L input and the key schedule to produce a 48-bit L_in_w input.

The logic in the initial stage may be represented by the following pseudo code:

L_{—}in_{—}w=E(L_{—}in)̂K0[47:0];

Thus, the input “L” state register (L0_wk) in the initial stage is expanded to 48 bits wide instead of a 32-bit wide state register. Instead of initializing the “L” state register with the L input bits, these bits are expanded to 48-bits and XORed with the initial key (K0) value. As the data loops through the “L” state element (Li_wk), the “L” state element always contains a pre-computed XOR with the next compression key that will be used. Thus, the “L” state domain (Li_wk) remains expanded to 48-bits and does not transform back to 32-bits after every 4 rounds.

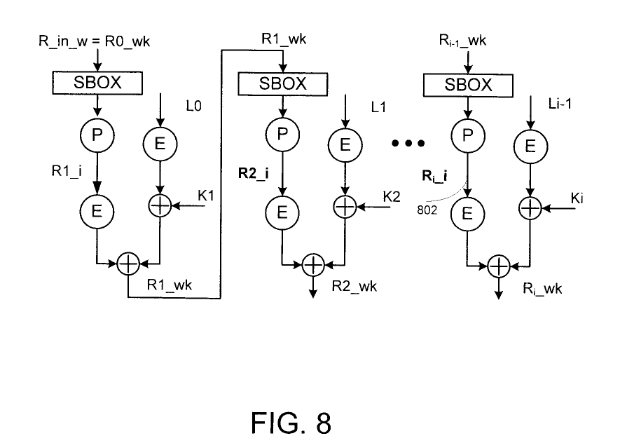

FIG. 8 is a block diagram of an embodiment of a cycle that performs a plurality of rounds of DES or 3DES according to the principles of the present invention. Psuedo code for the data path logic for four rounds, with four 32 bit input blocks R0-R3, L0-L3 and four 48-bit key schedules (K0-K3) to generate four 32-bit output blocks R1-R4 and L 1-L4 is shown below in Table 3.

TABLE 3

Round 1:

Critical R-path:

R1_i = P(sbox(R));
R1_wk = (E(L) \hat{ } K1) \hat{ } E(R1_i);

Non-Critical L-path:

L1= R0

Round 2:

Critical R-path:

R2_i = P(sbox(R1_wk));
R2_wk = (E(L1) \hat{ } K2) \hat{ } E(R2_i);

Non-Critical L-path:

L2= L0 \hat{ } R1_i

Round 3:

Critical R-path:

R3_i = P(sbox(R2_wk));
R3_wk = (E(L2) \hat{ } K3) \hat{ } E(R3_i);

Non-Critical L-path:

L3= L1 \hat{ } R2_i;

Round 4:

Critical R-path:

R4_i = P(sbox(R3_ wk));
R4_wk = (E(L3) \hat{ } K4) \hat{ } E(R4_i);

Non-Critical L-path:

L4 = L2 \hat{ } R3_i;

Pre-computing the initial XOR value into the “R” state element, allows one XOR to be reduced from the key DES critical path, that is, the R path In addition expanding the “R” state element width to 48-bits increases the symmetry of the data_path and allows for a higher performance implementation of the initial “sbox” lookup function. In contrast, in the composition function shown in FIG. 4, some of the 32 bit state elements 400 fill two bit positions in the expanded 48-bit input 400 for the initial “sbox” lookup function. The bits which supply data to two expanded bit positions tend to fan-out to more logic than those state bits which only supply data to one bit in the 48-bit expanded data, and these higher fan-out bits tend to be slower than those bits which do not fan-out to multiple bit positions. Increasing the state element to 48-bits balances out this asymmetric fan-out and allows for a higher performance implementation of the initial “sbox” lookup function.

For higher speed implementations with fewer rounds per cycle, the overall effect of this performance increase will be even more pronounced due to the saving of one XOR on the critical path independent of the number of rounds completed per cycle. For example for a 2 round hardware implementation, the number of XORs in the critical paths is reduced from 3 to 2.

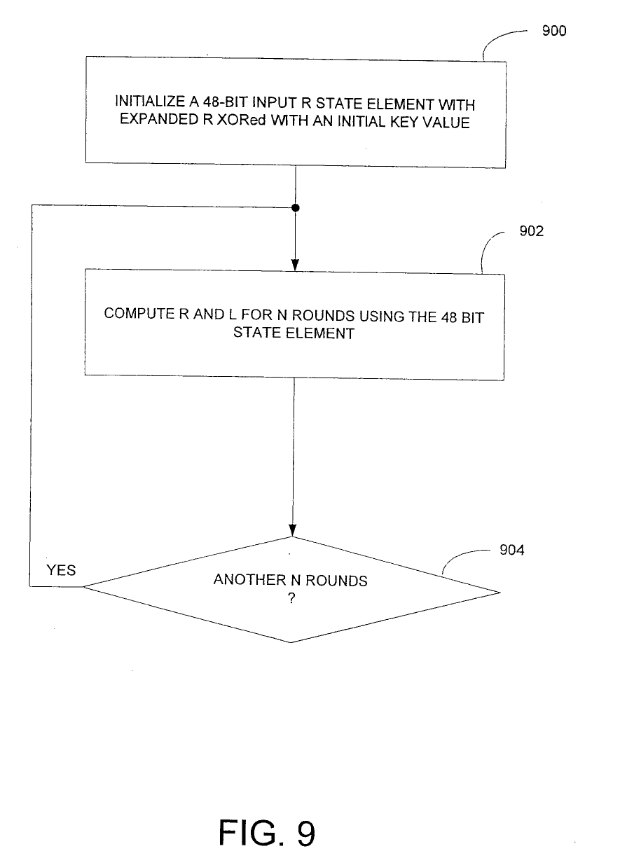

FIG. 9 is a block diagram of an embodiment of a cycle 918 that performs four rounds of DES or 3DES and inter-cycle logic 920. Cycle 918 performs four rounds of DES or 3DES as described in conjunction with FIG. 8. The inter-cycle logic 920 handles the critical R path and the non-critical L path prior to the initial cycle and between subsequent cycles.

The inter-cycle logic 920 includes a multiplexer 906 and R-state register 908 for the critical R-path and a multiplexer 904 and L-state register 906 for the non-critical L path. In the R-path, prior to the initial cycle, the multiplexer 906 allows the initial R state R0_wk through to the R_state register 908 as discussed in conjunction with FIG. A. In the L-path, prior to the initial cycle, the multiplexer 904 allows the initial L state L0_wk through to the L-state register 906.

Psuedo code for the data path logic for n rounds, with four 32 bit input blocks R0-R3, L0-L3 and four 48-bit key schedules (K0-K3) to generate four 32-bit output blocks R1-R4 and L1-L4 is shown below in Table 4

TABLE 4
Round 1:
Let R0_wk = E(R0) \hat{ } K0 and

L0_wk = E(L0) \hat{ } K0 and
K0_x = K0 \hat{ } K1

Critical R-path:

| | R1_i = P(sbox(R0_wk)); |
|---|---|
| | R1_wk = E(R1_i) \hat{ } (E(L0) \hat{ } K1); |
| [symbol] | R1_wk = E(R1_i) \hat{ } (L0_wk \hat{ } K0_x) |

Round 2:
Let L1_wk = R0_wk, where R0_wk = E(R0) \hat{ } K0 and

K1_x = K0 \hat{ } K2

Critical R-path:

| | R2_i = P(sbox(R1_wk)); |
|---|---|
| | R2_wk = E(R2_i) \hat{ } (E(L1) \hat{ } K2); |
| [symbol] | R2_wk = E(R2 i) \hat{ } E(R0) \hat{ } K2; |
| [symbol] | R2_wk = E(R2_i) \hat{ } (L1_wk \hat{ } K1_x) |

Round 3:
Let L2_wk = R1_wk, where R1_wk = E(R1) \hat{ } K1 and

K2_x = K1 \hat{ } K3

Critical R-path:

| | R3_i = P(sbox(R2_wk)); |
|---|---|
| | R3_wk = E(R3_i) \hat{ } (E(L2) \hat{ } K3); |
| [symbol] | R3_wk = E(R3_i) \hat{ } E(R1) \hat{ } K3; |
| [symbol] | R3_wk = E(R3_i) \hat{ } (L2_wk \hat{ } K2_x) |

Round 4:
Let L3_wk = R2_wk, where R2_wk = E(R2) \hat{ } K2 and

K3_x = K2 \hat{ } K4

Critical R-path:

| | R4_i = p(sbox(R3_wk)); |
|---|---|
| | R4_wk = E(R4_i) \hat{ } (E(L3) \hat{ } K4); |
| [symbol] | R4_wk = E(R4_i) \hat{ } E(R2) \hat{ } K4; |
| [symbol] | R4_wk = E(R4_i) \hat{ } (L3_wk \hat{ } K3_x) |

Round 5:
Let L4_wk = R3_wk, where R3_wk = E(R3) \hat{ } K3 and

K4_x = K3 \hat{ } K5

Critical R-path:

| | R5_i = P(sbox(R4_wk)); |
|---|---|
| | R5_wk = E(R5_i) \hat{ } (E(L4) \hat{ } K5); |
| [symbol] | R5_wk = E(R5_i) \hat{ } E(R3) \hat{ } K5; |
| [symbol] | R5_wk = E(R5_i) \hat{ } (L4_wk \hat{ } K4_x) |

Round i: i = 1 .. n-2 (where n = 16 for DES and n = 48 for 3DES)
Let Lᵢ₋₁_{_{—}}wk = Rᵢ₋₂_{_{—}}wk, where Rᵢ₋₂_{_{—}}wk = E(Rᵢ₋₂) \hat{ } Kᵢ₋₂ and

Kᵢ₋₁_{_{—}}x = Kᵢ₋₂ \hat{ } Kᵢ

Critical R-path:

| | Ri_i = P(sbox(Rᵢ₋₁_{_{—}}wk)); |
|---|---|
| | Ri_wk = E(Ri_i) \hat{ } (E(Lᵢ₋₁) \hat{ } Kᵢ); |
| [symbol] | Ri_wk = E(Ri_i) \hat{ } E(Rᵢ₋₂) \hat{ } K_{i;} |
| [symbol] | Ri_wk = E(Ri_i) \hat{ } (Lᵢ₋₁_{_{—}}wk \hat{ } Kᵢ₋₁_{_{—}}x) |

Round i: i = n −1 (second to the last round, for DES, this is 15 and
for 3DES, this is 47)
Let L₄₆_{_{—}}wk = R₄₅_{_{—}}wk, where R₄₅_{_{—}}wk = E(R₄₅) \hat{ } K₄₅ and

K₄₆_{_{—}}x = K₄₅ \hat{ } K₄₇

Critical R-path:

| | R₄₇_{_{—}}i = P(sbox(R₄₆_{_{—}}wk)); |
|---|---|
| | R₄₇_{_{—}}wk = E(R₄₇_{_{—}}i) \hat{ } (E(L₄₆) \hat{ } K₄₇) |
| [symbol] | R₄₇_{_{—}}wk = E(R₄₇_{_{—}}i) \hat{ } E(R₄₅) \hat{ } K₄₆_{_{—}}x |

Round i: i = n (last round, for DES, this is 16 and for 3DES, this is 48)
Let L₄₇_{_{—}}wk = R₄₆_{_{—}}wk, where R₄₆_{_{—}}wk = E(R₄₆) \hat{ } K₄₆ and

K₄₇_{_{—}}x = K₄₆

Critical R-path:

R₄₈_{_{—}}i = P(sbox(R₄₇_{_{—}}wk));

Using the logic used by all other rounds,

| | R₄₈_{_{—}}wk = E(R₄₈_{_{—}}i) \hat{ } L₄₇_{_{—}}wk \hat{ } K₄₇_{_{—}}x |
|---|---|
| [symbol] | R₄₈_{_{—}}wk = E(R₄₈_{_{—}}i) \hat{ } E(R₄₆) |
| [symbol] | R₄₈_{_{—}}wk = E(R₄₈_{_{—}}i) \hat{ } E(L₄₇) |
| [symbol] | R₄₈_{_{—}}wk = E(R₄₈_{_{—}}i \hat{ } L₄₇) |
| [symbol] | R₄₈_{_{—}}wk = E(R₄₈) |

Final Processing performed outside of the 4 round cycle:
L₄₈ = R47 = E⁻¹ (R₄₇_{_{—}}_{wk} \hat{ } K₄₇)*
R₄₈ = E⁻¹ (R₄₈_{_{—}}_{wk})
The XOR logic for the final processing may be external to the 4 round cycle shown in FIG. 9. This XOR logic adds to the latency but does not add any delay through the critical R path.
E⁻¹ is the inverse of the E (Expansion function and involves rerouting only).

FIG. 10 is a flowgraph that illustrates an embodiment of a method for performing a DES/3DES crypto operation according to the principles of the present invention. FIG. 10 will be described in conjunction with FIGS. 7 and 8.

At block 1000, a 48-bit input R state element (R_in_w) is initialized with an expanded input R (R_in) vector that has been expanded from 32-bits to 48-bits XORed with the 48-bit initial key value (K0[47:0]) as shown below and discussed in conjunction with FIG. 7:

R_{—}in_{—}w=E(R_{—}in)̂K0[47:0];

Processing continues with block 1002.

At block 1002, the state elements operate on the 48-bit R state element, the 48-bit key values and the 32-bit L values to provide a 48-bit R value and a 32-bit L value per round for each of N rounds as shown in Table 3 and discussed in conjunction with FIG. 8. At the end of N rounds, processing continues with block 1004.

At block 1004, if there are another N rounds to be computed for DES or 3DES, processing continues with block 1002 to compute the next N rounds. If not, processing is complete, with the 32-bit R for the last round of DES/3DES output from ? and the 32-bit L for the last round of DES/3DES computed as shown in Table 4.

It will be apparent to those of ordinary skill in the art that methods involved in embodiments of the present invention may be embodied in a computer program product that includes a computer usable medium. For example, such a computer usable medium may consist of a read only memory device, such as a Compact Disk Read Only Memory (CD ROM) disk or conventional ROM devices, or a computer diskette, having a computer readable program code stored thereon.

While embodiments of the invention have been particularly shown and described with references to embodiments thereof; it will be understood by those skilled in the art that various changes in form and details may be made therein without departing from the scope of embodiments of the invention encompassed by the appended claims.

1. A method comprising:
performing a cipher operation on a block of data, the block of data comprising an R vector and an L vector by:
pre-computing an R state element in an R state domain by expanding the width of the R vector and performing an exclusive OR (XOR) operation on the expanded R vector and a first key in a key schedule; and
circulating the expanded R vector through M cycles, each cycle having N round stages and each round stage receiving an associated key in the key schedule, each round stage performing a function on the expanded R vector and the associated key, the R state domain remaining expanded for all M cycles.

2. The method of claim 1, wherein the R vector has 32-bits, the L vector has 32-bits, the expanded key has 48-bits and the key has 48-bits.

3. The method of claim 2, wherein N is 4 and each round performs one XOR operation in the R data path.

4. The method of claim 3, wherein M is 4 and the cipher operation is Data Encryption Standard (DES).

5. The method of claim 3, wherein M is 12 and the cipher operation is three Data Encryption Standard (3DES).

6. The method of claim 1, wherein the cipher operation is encryption.

7. The method of claim 1, wherein the cipher operation is decryption.

8. An apparatus comprising:
a crypto unit, the crypto unit to perform a cipher operation on a block of data, the block of data comprising an R vector and an L vector. the crypto unit comprising:
a pre-compute logic to pre-compute an R state element in an R state domain by expanding the width of the R vector and performing an exclusive OR (XOR) operation on the expanded R vector and a first key in a key schedule; and
N round stages, a first round stage coupled to the pre-compute logic to receive the R state element, each round stage to perform a function on the expanded R vector received from a prior round stage and a key in the key schedule associated with the round stage, the expanded R vector to circle through M cycles of the N round stages, the R state domain remaining expanded for all M cycles.

9. The apparatus of claim 8, wherein the R vector has 32-bits, the L vector has 32-bits, the expanded key has 48-bits and the key has 48-bits.

10. The apparatus of claim 9, wherein N is 4 and each round performs one XOR operation in the R data path.

11. The apparatus of claim 10, wherein M is 4 and the cipher operation is Data Encryption Standard (DES).

12. The apparatus of claim 10, wherein M is 12 and the cipher operation is three Data Encryption Standard (3DES).

13. The apparatus of claim 8, wherein the cipher operation is encryption.

14. The apparatus of claim 8, wherein the cipher operation is decryption.

15. An article including a machine-accessible medium having associated information, wherein the information, when accessed, results in a machine performing:
performing a cipher operation on a block of data, the block of data comprising an R vector and an L vector by:
pre-computing an R state element in an R state domain by expanding the width of the R vector and performing an exclusive OR (XOR) operation on the expanded R vector and a first key in a key schedule; and
circulating the expanded R vector through M cycles, each cycle having N rounds and each round having an associated key in the key schedule, each round performing a function on the expanded R vector and the associated, the R state domain remaining expanded for all M cycles.

16. The article of claim 15, wherein the R vector has 32-bits, the L vector has 32-bits, the expanded key has 48-bits and the key has 48-bits.

17. The article of claim 16, wherein N is 4 and each round performs one XOR operation in the R data path.

18. The article of claim 17, wherein M is 4 and the cipher operation is Data Encryption Standard (DES).

19. The article of claim 17, wherein M is 12 and the cipher operation is 3 Data Encryption Standard (3DES).
